(19) United States
(12) Patent Application Publication
(10) Pub. No.: US 2026/0209568 A1
(43) Pub. Date: Jul. 23, 2026

(54) A CORROSION PROTECTIVE WRAPPING

(71) Applicant: George Brownlow, Johannesburg (ZA)

(72) Inventor: George Brownlow, Johannesburg (ZA)

(21) Appl. No.: 19/138,439

(22) PCT Filed: Nov. 9, 2023
(86) PCT No.: PCT/ZA2023/050072

§ 371 Date: Jun. 12, 2025

(30) Foreign Application Priority Data
Dec. 13, 2022 (ZA) 2022/13443

(51) Int. Cl. C09J 7/38; C09J 7/24; C09J 11/04; F16L 58/16

(52) U.S. Cl. CPC C09J 7/381; C09J 7/241; C09J 11/04; F16L 58/16; C09J 2301/408; C09J 2423/006

(57) ABSTRACT

The invention provides a corrosion protective wrapping designed for surface application. This wrapping features a flat, tape-like structure with both inner and outer surfaces. It consists of two distinct layers: a first layer made of homo-polymeric RIB with a specific molecular density, adapted for adhesive qualities, forming the inner surface; and a second layer composed of homo-polymeric PIB with a different molecular density or an elastomeric polymer, adapted for mechanical resilience, creating the outer surface. These two layers adhere to each other along a compatibility plane.

### FIELD OF THE INVENTION

This invention relates to a corrosion protective wrapping for application to a surface of a structural element such as, for example, a pipe or a roofing sheets.

### BACKGROUND OF THE INVENTION

Hereinafter, the words “tape” and “band” are used interchangeably to refer to a long, relatively narrow, flexible strip of a material used for mechanical corrosion protection of a surface of a structural element.

Any structural element which is exposed to corrosive elements would require the application of a corrosion resistant coat to preserve the structure and increase the functional life span of the structural element.

There are many methods employed to coat a surface of a structural element with a corrosion resistant material. A common method, particularly when coating underground pipelines which are used to convey water, sewerage, oil, gas, and petrochemical fluids for example, is to wrap a tape or band of the corrosion resistant material around the pipe sections.

A typical wrapping method for applying a corrosion resistant layer to a pipe section involves a complicated, expensive, multi-step process which includes some or all the following steps: 1. preheating the pipe section; 2. blast cleaning an outer surface of the pipe section to a required standard; 3. surface grinding the outer surface; 4. selecting a surface profile; 5. inspecting the outer surface; 6. test for surface residue, i.e., chloride salts; 7. applying a primary primer coat (an anti-corrosion paint or wet applied anti corrosion material) to the outer surface; 8. wrapping an adhesive tape around the pipe section, to provide a corrosion resistant adhesive layer; 9. applying a mechanically resistant overwrap of PVC, PP, HDPE, or the like to the adhesive layer, to provide a mechanical layer; and 10. inspecting the pipe section for discontinuities in the coats with an electrical conductivity test.

As evident, the pipe section requires extensive pre-coating preparation to ensure that the outer surface is clean and absent of any film or scale and has a surface profile of the required standard, being SA 2.5 to 3, to ensure that the primary coat adheres to the outer surface.

The adhesive layer typically is an adhesive comprising a mixture of butyl and bitumen, the mix ratio of which varies according to manufacturer and function, but which is aimed at achieving a high-level of adhesion. The problem with this adhesive blend is that it loses flexibility over time and become brittle.

The adhesive layer plays a crucial role in attaching the outer protective layer to the pipe. To make sure this adhesive layer is sticky enough, preferably it should be a homopolymer. This requirement excludes the cost cutting opportunity of using a co-polymeric PIB because co-polymeric PIB is less sticky and more likely to corrode.

PIB is a general term used to describe, not only a homopolymer of isobutylene (isobutylene being the only constituent monomer), but also a copolymer or a terpolymer which consists of isobutylene and other monomers.

Co-polymeric PIB (Co-PIB) is created by copolymerizing isobutylene with other monomers, resulting in a polymer with a combination of properties from the different monomers. Co-PIB offers versatility and customization options for various industrial and commercial applications.

An example of a Co-PIB copolymer is Isobutylene Isoprene Rubber (IIR) which is a type of PIB-based rubber with repeating units of both isobutylene and isoprene. It is known for its exceptional impermeability to gases and is commonly used in the production of inner tubes for tires, O-rings, and other products requiring high gas barrier properties.

Homo-polymeric PIB (Ho-PIB) is made solely from isobutylene monomers, resulting in a highly uniform and consistent polymer structure. It is often used in applications requiring reliable and consistent properties, such as in the adhesive industry.

PIB can be further classified into three classes based on molecular weight, irrespective of whether they are Ho-PIB or Co-PIB, which are: (1) Low Molecular Weight PIB (LMW PIB) has a relatively low molecular weight, having a molecular weight range 500-10,000 g/mol, which means it consists of fewer repeating units in its polymer chain, which is typically a low-viscosity liquid at room temperature, and which is often used as a lubricant, as an additive in motor oils, and in the production of certain sealants and adhesives; (2) Medium Molecular Weight PIB (MMW PIB) has a moderate molecular weight, having a molecular weight range 10,000-100,000 g/mol, falling between low and high molecular weight PIB, it is used in applications such as adhesive manufacturing, where a balance between viscosity and tackiness is required; and (3) High Molecular Weight PIB (HMW PIB) has a high molecular weight, having a molecular weight range above 100,000 g/mol, meaning it has a long polymer chain with many repeating units, which is typically a high-viscosity liquid or a solid at room temperature, which is a grade that offers mechanical strength, impact resistance, chemical resistance and rubber-like properties in general.

As apparent from the above discussion, the typical wrapping method is a multi-step process employing a three-layered coating process which adds complexity and cost.

It would therefore be advantageous to conceive a single wrap product which has a sticky molecular attachment property on one surface, and a mechanically stress resistant outer surface. This imperative typically would demand two layers of differing chemical composition being adhered together. Adhering two such layers together create a potentially costly solution which would have an interface which weakens the integrity of the resultant product.

The present invention at least partially addresses the problem.

### SUMMARY OF INVENTION

Hereinafter, “Homo-polymeric PIB” means a polymer made only of the monomer isobutylene (also known as isobutene) and which includes a mixture of homo-polymeric PIB with various additives or other materials to achieve specific performance characteristics or properties.

“Mechanically resistant” when used to describe a second layer, means that the layer, and the material it is comprised of, is relatively resistant to at least fatigue, stress, heat, and oxidation and impact, when compared to the first layer.

In the context of the first layer, the term “adhesive” implies that this layer, along with the material it consists of, exhibits a relatively high level of adhesion, stickiness, or tackiness compared to the second layer. The material is capable of forming molecular-level bonds with metallic, polymer-based, and cementitious substrates.

The invention provides a corrosion protective wrapping comprised of at least homo-polymeric PIB, for application to a surface, which has elongated planar tape-like body with an inner-facing surface and an outer-facing surface, and which includes, at least:
a first layer comprising a first material of homo-polymeric PIB in a first molecular density, which is adapted to have adhesive properties, and which provides the inner-facing surface; and
a second layer comprising a second material which includes at least homo-polymeric PIB in a second molecular density, or an elastomeric polymer, which is adapted to have mechanically resistant properties, and which provides the outer-facing surface; and
wherein the first and the second layers cohere along a compatibility plane.

The elastomeric polymer may include natural rubber or any one or more of the following synthetic polymers: isobutylene isoprene rubber (IIR), ethylene propylene diene monomer rubber (EPDM), ethylene propylene rubber (EPR), ethylene-octene (EO), ethylbenzene (EB), and styrene ethylene butadiene styrene (SEBS).

The first molecular density of the first material of homo-polymeric PIB may be in a range 25 to 65g/cm³.

The first material of homo-polymeric PIB may be a MMW PIB.

Preferably, the first material of a homo-polymeric PIB may be a blend of constituent polymers, aiming to attain an average molecular weight between 40,000 g/mol and 85,000 g/mol.

The ratio of each constituent polymer in the blend may be dependent upon, at least, the temperature in the context in which the wrapping is to be used.

Preferably, each constituent polymer in the blend has an average molecular weight of 1,500; 2,400; 20,000; 36,000; 56,000; or 75,000.

The first layer may have a thickness of between 200 μm and 3000 μm.

Preferably, the first layer has a thickness between 500 μm and 900 μm.

The first material of homo-polymeric PIB may include any one or more of the following additives (added to the first material to form a mixture): an antioxidant, a colourant, and a bulking agent (filler).

The bulking agent may be glass beads, preferably hollow glass beads, having a diameter equivalent to the desired thickness of the first layer.

The second molecular density of the second material of homo-polymeric PIB may be in a range 120 and 180g/cm³.

The second material of homo-polymeric PIB may be a HMW PIB.

Preferably, the second material of a homo polymeric PIB may be a blend of polymers to achieve an average molecular weight between 200,000 g/mol and 4,000,000 g/mol.

The ratio of each constituent polymer in the blend may be dependent upon, at least, environmental parameters (in the context in which the wrapping is to be used) such as exposure to oxidation and temperature, as well as functional parameters such as impact characteristics.

Preferably, each constituent polymer in the blend has an average molecular weight of 750,000; 2,500,000 or 4, 100,000.

The second layer may have a thickness of between 500 μm and 5000 μm

Preferably, the second layer has a thickness of between 800 μm and 1000 μm.

The second material of homo-polymeric PIB may include one or more of the following additives (added to the second material to form a mixture): an antioxidant, a colourant, a processing aid, and a bulking agent (filler).

The bulking agent may be glass beads, preferably hollow glass beads, having a diameter equivalent to the desired thickness of the second layer.

The elongate planar tape-like body of the wrapping may have a width in a range 50 mm to 400 mm.

The structural element may be a pipe section, a roof sheet, or the like.

The first and the second layers may cohere along a compatibility line by applying to the second layer, a liquefied first material of homo-polymeric material, to provide the first layer.

### BRIEF DESCRIPTION OF THE DRAWINGS

An embodiment of the invention is now described by way of a non-limiting example only with reference to the drawings in which:

FIG. 1 isometrically illustrates a section of a corrosion resistant wrapping in accordance with the invention;

FIG. 2 isometrically illustrates the section of FIG. 1, with a first layer of the wrapping partially pulled away from a second layer of the wrapping; and

FIG. 3 is a view in cross-section of a pipe to which the wrapping is applied.

### DETAILED DESCRIPTION OF PREFERRED EMBODIMENT

“Mixture” or “blend” in the context of a PIB material, are terms that are used interchangeably to refer to a mixture that combines constituent PIB polymers of known average molecular weight with various additives or other materials to achieve specific performance characteristics or properties. These additives are blended with the PIB polymers to modify its behaviour, enhance its functionality, or adapt it for various applications. The resulting compound can have a range of properties tailored to meet the requirements of a particular industry or use case. Some common additives and materials that may be combined with PIB to create a compound include (1) fillers (like carbon black, silica, or clay) added to improve the compound's mechanical strength, wear resistance, and dimensional stability; (2) plasticizers added to enhance the flexibility and flow characteristics of the compound, making it more adaptable for specific applications, such as sealants or adhesives; (3) anti-oxidants added to prevent the oxidation of the PIB, which can degrade its performance over time; (4) vulcanizing agents which, in the case of PIB-based rubber compounds like isobutylene isoprene rubber (IIR), are used to cross-link the polymer chains and improve the material's strength and elasticity; (5) processing aids added to aid in the manufacturing and processing of PIB compounds, improving their workability and ease of application; (6) colorants or dyes added to provide a specific colour or appearance to the compound, which can be useful for identification or aesthetic purposes; (7) stabilizers, used to protect the compound from degradation caused by heat, UV radiation, or other environmental factors.

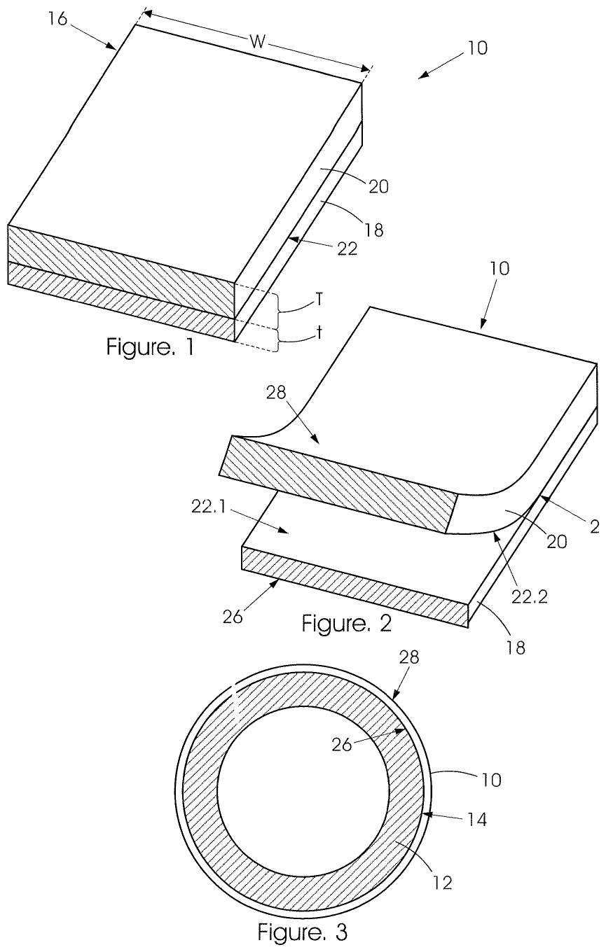

With reference to FIGS. 1 and 2, a corrosion protective wrapping 10 is provided in accordance with the invention.

In FIG. 3, the wrapping is applied to a steel pipe 12, for example. The pipe has an outer surface 14 that requires protection from corrosion.

The corrosion resistant wrapping 10 includes an elongate planar tape-like body 16 of indefinite length, preferably supplied in rolls which are unravelled prior to use, or sections, and which has a width (designated W) of between 50 mm and 400 mm, depending upon the application.

The body has a first layer 18, with a thickness (designated “t”) between 800 μm to 3000 μm, and a second layer 20, with a thickness (designated “T”) between 800 μm to 5000 μm, which are adhered together co-extensively by a co-extrusive manufacturing process, along respective inner surfaces (respectively designated 22.1 and 22.2).

The benefit of having the two layers being monomerically the same and made of PIB is that the layers cohere together almost seamlessly without the need for an additive adhesive. However, for purposes of the description and in defining the two layers, a compatibility line or plane 24 between the two layers is designated.

The first layer and the second layer present exposed surfaces, a substrate adhering (or inner-facing) surface 26, and an outer-facing surface 28 respectively.

In use, the wrapping 10 is adhered to the substrate, in this example, the pipe 12, by applying the substrate adhering surface 26 to the pipe's outer surface 14.

Both the first layer 18 and the second layer 20, in this example, are monomerically homogenous, made of PIB. PIB has all the necessary attributes for a wrapping of this kind. It is tacky, chemically and UV resistant, and elastic (returns to original size after deformation) whilst providing good mechanical, impact resistance and hoop strength. Furthermore, PIB never becomes brittle or dry and is always capable of flow.

The first layer includes a first PIB material which includes PIB with an average molecular weight (MMW) in the range 40,000 to 85,000 g/mol. In this range, the PIB has tackiness that provides for particularly good adhesion to all substrates including metallic, polymeric, cementitious materials, and glass and other materials with a low micron surface roughness.

To achieve a specific average molecular weight for this first PIB material, the selection will depend on the ambient temperature where the wrapping will be used. This involves blending known constituent PIB polymers with various average molecular weights, chosen from polymers with average molecular weights of 1,500; 2,400; 20,000; 36,000; 56,000; or 75,000.

The second layer includes a second PIB material which includes PIB with an average molecular weight (HMW) in the range 200,000 to 4,000,000 g/mol. In this range, the higher molecular weight confers on the material the mechanical properties of an elevated crushproof resistance, high impact resistance, scuff and abrasion resistance, UV resistant, with gas blocking attributes, whilst still being of high elasticity, hoop strength and flexibility.

To attain a particular average molecular weight for this second PIB material, the selection process will consider various factors beyond just the ambient temperature in the environment where the wrapping will be utilized. These additional factors encompass considerations for oxidation and impact exposure, influencing the choice of molecular weight for the material. This involves blending known constituent PIB polymers with various average molecular weights, chosen from polymers with average molecular weights of 750,000; 2,500,000 or 4,100,000.

The corrosion protective wrapping 10 can be fabricated using one of three distinct manufacturing techniques: single extrusion, co-extrusion, and roll-flat sheeting.

Single Extrusion is a manufacturing process utilized to produce flat profiles with consistent cross-sectional shapes. This process entails the introduction of a raw material, typically a thermoplastic or rubber, into a heated barrel. Subsequently, the material is molten within the barrel and is then propelled through a die, which imparts the desired shape. The resultant outcome is a continuous and uniform profile characterized by consistent material composition throughout.

Co-extrusion represents a variation of the extrusion process in which two or more materials are simultaneously extruded to form a single product with multiple layers. In this approach, each material is independently fed into its dedicated extruder. The molten materials are then amalgamated within a specialized die to generate a multi-layered structure. Co-extrusion is frequently employed to enhance specific product attributes, including the addition of protective layers for improved durability or the amalgamation of diverse colours or materials to fulfil aesthetic or functional requirements.

In instances where co-extrusion involves the use of polymers with different molecular weights but of the same type, two or more extruders are engaged in the process. Each extruder contains the identical polymer, albeit with distinct molecular weights. These materials are mixed with additives to confer attributes like coloration, uniform colour distribution, adhesiveness, and mechanical properties. These distinct materials are subsequently brought together within the die head or specialized manifold prior to being co-extruded into a single product. This approach, employing polymers of differing molecular weights but of the same type, enables the harnessing of unique properties associated with distinct molecular weight polymers within a singular product.

Generally, the polymer with the higher molecular weight tends to contribute to properties such as strength and rigidity, while the lower molecular weight polymer offers advantages like flexibility and impact resistance. The combination of materials with varying molecular weights enables the engineering of products possessing a broad spectrum of physical and mechanical properties, rendering this process highly versatile and suitable for a multitude of applications.

This method affords superior control over the final product's properties, thereby augmenting its performance, durability, and functionality.

Roll flat sheeting is a manufacturing method employed to fabricate thin, planar sheets from various materials. In this process, the material is generally introduced through a sequence of rollers that gradually reduce its thickness while creating a flat, uniform sheet. Roll flat sheeting finds utility across a wide array of industries, where the material is often pre-melted in an extruder before being conveyed to the rollers to achieve the desired dimensions.

The same type of polymer but with distinct molecular weights are then brought together in the die head or a specialized manifold before being extruded into a single product.

The polymer with a higher molecular weight typically contributes to properties such as strength and rigidity, impact capabilities, while the lower molecular weight polymer offers benefits like flexibility and adhesion with multi substrates.

Combining various constituent polymers with diverse molecular weights within each layer, and subsequently merging two layers with differing molecular weights, as outlined in the invention, enables the creation of a wide array of customized products. These products are tailored to exhibit distinct physical and mechanical properties, specifically designed for particular applications. Hence, this innovation introduces versatility to an industry previously limited by available products and application processes.

PIB is the preferred polymer of the invention due to its robust adherence to a wide array of substrates while maintaining fluidity without solidifying. Nonetheless, within the scope of the invention, it is foreseen that IIR, or butyl rubber, could serve as a substitute for PIB in the second layer. However, this substitution comes with a drawback; although IIR is less expensive, it tends to deteriorate over time, compromising its technical performance.

1. A corrosion protective wrapping comprised of at least homo-polymeric PIB, for application to a surface, which has elongated planar tape-like body with an inner-facing surface and an outer-facing surface, and which includes, at least a first layer comprising a first material of homo-polymeric PIB in a first molecular density, which is adapted to have adhesive properties, and which provides the inner-facing surface, and a second layer, comprising a second material of at least homo-polymeric PIB in a second molecular density or an elastomeric polymer, which is adapted to have mechanically resistant properties, and which provides the outer-facing surface, and wherein the first and the second layers cohere along a compatibility plane.

2. A corrosion protective wrapping according to claim 1 wherein the elastomeric polymer includes natural rubber or any one or more of the following synthetic polymers: isobutylene isoprene rubber (IIR), ethylene propylene diene monomer rubber (EPDM), ethylene propylene rubber (EPR), ethylene-octene (EO), ethylbenzene (EB), and styrene ethylene butadiene styrene (SEBS).

3. A corrosion protective wrapping according to claim 1 wherein the first molecular density of the first material of homo-polymeric PIB is in a range 25 to 65g/cm³.

4. A corrosion protective wrapping according to claim 1 wherein the first material of a homo polymeric PIB is a blend of polymers to achieve an average molecular weight between 40,000 g/mol and 85,000 g/mol.

5. A corrosion protective wrapping according to claim 4 wherein each constituent polymer in the blend has an average molecular weight of 1,500, 2,400, 20,000, 36,000, 56,000, or 75,000.

6. A corrosion protective wrapping according to claim 1 wherein the first layer has a thickness of between 200 μm and 3000 μm.

7. A corrosion protective wrapping according to claim 6 wherein the first layer has a thickness of 500 μm to 900 μm.

8. A corrosion protective wrapping according to claim 1 wherein the first material of homo-polymeric PIB includes any one or more of the following additives: an antioxidant, a colourant, and a bulking agent.

9. A corrosion protective wrapping according to claim 8 wherein the bulking agent is glass beads or hollow glass beads, having a diameter equivalent to the desired thickness of the first layer.

10. A corrosion protective wrapping according to claim 1 wherein the second molecular density of the second material of homo-polymeric PIB is in a range of 120 g/cm³ to 180g/cm³.

11. A corrosion protective wrapping according to claim 1 wherein the second material of a homo polymeric PIB is a blend of polymers to achieve an average molecular weight between 200,000 g/mol and 4,000,000 g/mol.

12. A corrosion protective wrapping according to claim 1 wherein each constituent polymer in the blend has an average molecular weight of 750,000, 2,500,000 or 4,100,000.

13. A corrosion protective wrapping according to claim 1 wherein the second layer has a thickness in a range of 500 μm to 5000 μm.

14. A corrosion protective wrapping according to claim 13 wherein the second layer has a thickness of 800 μm to 1000 μm.

15. A corrosion protective wrapping according claim 1 wherein the second material of homo-polymeric PIB includes one or more of the following additives: an antioxidant, a colourant, a processing aid, and a bulking agent.

16. A corrosion protective wrapping according to claim 15 wherein the bulking agent is glass beads, or hollow glass beads, having a diameter equivalent to the desired thickness of the second layer.

17. A corrosion protective wrapping according to claim 1 wherein the elongate planar tape-like body of the wrapping has a width in a range of 50 mm to 400 mm.

18. A corrosion protective wrapping according to claim 1 wherein the structural element is a pipe section.

19. A corrosion protective wrapping according to claim 1 wherein the first and the second layers cohere along a compatibility line by applying to the second layer, a liquefied first material of homo-polymeric material, to provide the first layer.
